(19) United States
(12) Patent Application Publication
(10) Pub. No.: US 2015/0371144 A1
(43) Pub. Date: Dec. 24, 2015

(54) CYCLIC PREDICTIONS MACHINE

(71) Applicant: Garett Engle, Palo Alto, CA (US)

(72) Inventor: Garett Engle, Palo Alto, CA (US)

(21) Appl. No.: 14/313,099

(22) Filed: Jun. 24, 2014

(51) Int. Cl. G06N 5/04; G06F 17/10

(52) U.S. Cl. CPC G06N 5/048; G06F 17/10

(57) ABSTRACT

Determining the value of an item or event at a point in time or over a targeted period of time based on the values of the item over a past era. During the past era, data is obtained to represent the changes to the value during the era. This data is iteratively processed by: smoothing the curve, subtracting the smooth curve from the original curve to obtain a next level curve and repeating the process. After several iterations, a set of smoothed out curves are obtain and the projected time-wise to encompass the targeted time or period of time. Once projected, the curves are then combined together and the value at the targeted time or period of time can then be ascertained.

### BACKGROUND

As the old saying goes, hindsight is 20-20. But unfortunately, it is usually too late. However, if one could really learn from their mistakes, or put more broadly, if one could really utilize the past to predict the future, then although hindsight is not really 20-20, it may operate to provide an appearance of 20-20 vision for the future, maybe even the appearance of a level of clairvoyance. People have probably been trying to predict the future since the startling surprise that occurred when Cain killed Able. There is just something about the uncertainty of the future that makes people want to peer into the future and see what is ahead. Of course there is always that person whose first thought is just predicting the winning lottery numbers but, on a more global sense, imagine a world in which you could feed known, measureable, quantifiable and readily available historical information into an engine that can assimilate, analyze and predict future events or trending. Such a machine would find applications across many industries. Such a machine is the subject of this disclosure.

### BRIEF SUMMARY

The present disclosure presents various embodiments, as well as features and aspects thereof, of a cyclic prediction machine. The various embodiments of the cyclic prediction machines may be described as performing three operations. The first operation is the generation of the solution levels. This process basically involves breaking down a historical curve representative of an event or item into one or more solution curves, each solution curve existing at a lower and lower level, or having less and less impact on predicting future activity. In essence, the data represented in the original historical curve is extracted and stored within the plurality of solution curves, with a final curve representing a margin of error or, the remainder of the historical data that was not captured within a solution curve. The next process involves unpacking the data in the solution curves to verify the validity of the solution curves. This process is not mandatory for embodiments of the cyclic prediction machine but rather, may optionally be employed to provide data verification. Although not mandatory in all embodiments, nonetheless the process in considered a novel aspect. The final process involves applying the solution curves that represent cyclical data that affects the item of concern, and using that information to project into the future or past and identify characteristics of the item of concern. Thus, the solution curves are combined and then extended in time. The cyclical aspects of each of the solutions allows the combined curves to be projected and then used to identify values or attributes of an item being evaluated at a particular point in the future or past.

An exemplary embodiment of the prediction machine can be implemented in software running on a processor, hardware, or a combination of both. In general, an exemplary embodiment may operate to identify the value of characteristics of an item at a point in time based on characteristic information representative of the item during a past era of time. Initially, the embodiment may receive chart data representative of one or more characteristics of an item during a past era of time. Using this chart data, the embodiment can iteratively extract varying degrees of characteristic information from the chart data, such as for n levels. The value of n can be chosen a priori, by empirical data obtained through experimentation, by monitoring performance (i.e., when the margin of error falls below a desired threshold), etc. as well as combinations of one or more techniques. For each degree of characteristic information, the data can be projected to a different point in time, either in the future or the past. Next, the projected data is iteratively combined to create new chart data representative of one or more characteristics of the item at a different point in time. At this point, it is clear that future values are predicted using the machine and past values are approximated for the data. In addition, based on this information, an action can be invoked based at least in part on the value of the one or more characteristics at the different point in time.

The embodiment operates to iteratively extract varying degrees of characteristic information from the chart data for a particular number of levels, such as n levels. The iterative process in one embodiment includes identifying the trend of the data represented in the current level chart data. The trend is basically the overall direction, pattern or tendency of the data and can be determined through a variety of techniques including averaging, window averaging, smoothing, etc. The process continues by extracting the characteristic information from the current level chart data as a function of the identified trend of the data and the current level curve data. The process is iterative in that the chart level used for the next level of iteration is based on the characteristic information, which in some embodiments is simply the difference between the original characteristic data and the trended out data. Thus, the next level chart data is set to be the characteristic information or remainder for the current level. Using the next level chart data the iterative process is repeated. After a number of iterations, margin of error remains as a function of the characteristic information and the chart data for the final level.

Projecting the data to a different point in time for each degree or level is performed on the trended out data and is accomplished by identifying a target point in time and then projecting a curve represented by the trended data for each level at least to that target point in time by continuing the trend and pattern of the data.

The projected data is combined iteratively to create new chart data representative of one or more characteristics of the item at a different point in time by performing the action of combining each level of the projected data at least for the data corresponding with the different point in time.

In some embodiments, the iterative process can be repeated for a fixed number of levels, such as n levels. In other embodiments, the iterative process may continue until the final remainder or characteristic information is within a threshold margin of error or is negligible. For instance, the final curve does not deviate above or below certain threshold levels or, on the average the curve does not exceed a certain threshold value.

In another exemplary embodiment, varying degrees of information are iteratively extracted from the chart data for a certain number of levels by smoothing the curve of the data represented in the current level chart data and setting a next level chart data to be the difference between the smoothed curve and the original chart data. This process is performed repetitively as described above.

As previously described, smoothing the curve can include calculating a moving average or using other smoothing techniques. The action of projecting the smoothed data to include the target point or period of time can involve at least two aspects. One aspect is examining the data to determine if there is a repeatable pattern within the smoothed data over a time period t and repeating the pattern over additional time periods t until the target point or period is included. Another aspect is determining if there is a trend within the smoothed data over time period t and continuing the trend over additional time periods t until the target point or period is included. In some cases, the data will not present a pattern and as such, the trend illustrated in the data can be followed.

Another embodiment of the predictive machine can be implemented within a computing environment and be configured to approximate characteristics of an item for a target point or period time based on characteristic information representative of the item during a past era of time. This embodiment operates by receiving data representative of one or more characteristics of an item during a past era of time. The process continues by extracting varying degrees of characteristic information from the characteristic data by applying a smoothing algorithm to the characteristic data over at least a portion of the past era, subtracting the smoothed data from the characteristic data to obtain remainder data and repeating the applying action and subtracting action two or more times with the remainder data. Once this process is completed, for each set of smoothed data, the process continues by projecting the smoothed data to include the target point or period of time and then combining the projected smoothed data to create projected characteristic data representative of the one or more characteristics of the item. Finally, the process operates by invoking an action based at least in part on the value of the one or more characteristics at the different point in time.

These embodiments as well as other embodiments, features and aspects will be further described in the following drawings and detailed description.

### BRIEF DESCRIPTION OF THE SEVERAL VIEWS OF THE DRAWING

FIG. 1 is a graphic chart illustrating an exemplary raw stock price history of what could be a random Fortune 500 stock.

FIG. 2 is a graphic chart illustrating the results of an exemplary cyclic prediction engine operating on the level 1 input illustrated in FIG. 1 to generate the trend of the data.

FIG. 3 is a graphic chart illustrating the generation of a level 1 solution by the cyclic prediction machine.

FIG. 4 is a graphic chart illustrating the level 1 solution overlaid with the level 1 raw data.

FIG. 5 is a graphic chart illustrating an output, or generated result, of the cyclic prediction machine in performing its final processing of the level 1 solution.

FIG. 6 is a graphic chart illustrating the first step in the level 2 processing by the cyclic prediction machine.

FIG. 7 is a graphic chart illustrating the results of an exemplary cyclic prediction engine operating on the level 2 input illustrated in FIG. 6 to generate the trend of the data.

FIG. 8 is a graphic chart illustrating the generation of a level 2 solution by the cyclic prediction machine.

FIG. 9 is a graphic chart illustrating the level 2 solution overlaid with the level 2 input data 502.

FIG. 10 is a graphic chart illustrating an output, or generated result, of the cyclic prediction machine in performing its final processing of the level 2 solution.

FIG. 11 is a graphic chart illustrating the first step in the level 3 processing by the cyclic prediction machine.

FIG. 12 is a graphic chart illustrating the results of an exemplary cyclic prediction engine operating on the level 3 input illustrated in FIG. 11 to generate the trend of the data.

FIG. 13 is a graphic chart illustrating the generation of a level 3 solution by the cyclic prediction machine.

FIG. 14 also illustrates the generated output, or generated result, of the cyclic prediction machine in performing its final processing of the level 3 solution.

FIG. 15 is a graphic chart illustrating the output from the level 3 processing 1402.

FIG. 16 is a graphic chart illustrating the level 1 solution curve 302.

FIG. 17 is a graphic chart illustrating the level 1 solution curve 302 along with the level 2 solution curve 802.

FIG. 18 is a graphic chart illustrating a resulting data curve created by combining the level 1 solution curve 302 with the level 2 solution curve 802.

FIG. 19 is a graphic chart illustrating a resulting data curve when all the entire solution set is added together.

FIG. 20 is a graphic chart illustrating an overlay of the original raw level 1 input data with the resulting data curve of FIG. 19.

FIG. 21 is a graphic illustration of the relationship between the resulting data curve from combining the three solutions and the original raw data curve.

FIG. 22 is a graphic illustration of the solution curves for level 1-3 with the level 1 solution curve being projected or extended forward.

FIG. 23 is a graphic illustration of the solution curves for level 1-3 with the level 1 and level 2 solution curves being extended forward in time.

FIG. 24 is a graphic illustration of the solution curves for level 1-3 with the level 1, level 2 and level 3 solution curves being extended forward in time.

FIG. 25 is a graphic illustration of the extended solution curves for level 1-3 being combined.

FIG. 26 is a graphic chart illustration of the extended combined data curve along with the historical raw data curve for the item being evaluated.

FIGS. 27A-27C is a flow diagram illustrating the exemplary actions taken by an exemplary cyclic prediction machine.

FIG. 28 is a functional block diagram of the components of an exemplary embodiment of system or sub-system operating as a controller or processor 2800 that could be used in various embodiments of the disclosure for controlling or implementing various aspects of the various embodiments or various embodiments of the cyclic prediction machine.

### DETAILED DESCRIPTION OF VARIOUS EMBODIMENTS

The present disclosure presents various embodiments, as well as features and aspects thereof, that are directed towards a cyclic prediction machine that can provide predictions of future events based on an analysis of past cyclic behaviors. In general, the premise of the cyclic prediction machine is based on the principal that everything or most everything, runs or operates in a cycle. In addition, everything has energetic influences or forces that act upon it. These energetic influences or forces also tend to move, vary or operate cyclically as well. Furthermore, these forces cycle at various levels. As a non-limiting example to further illustrate this concept, one could examine a particular stock price. There are some forces that operate to influence the price of the stock over the entire lifecycle of the company while other forces may have a shorter duration of influence, such as months, weeks, days, hours, etc.

The concept of the energetic influences or forces that cycle at various levels can be illustrated in an analogy with the planetary bodies within our solar system. The Sun has a very long cycle as it orbits around the Milky Way galaxy. However, the Earth orbits around the Sun at a much faster pace. Similarly, the Earth has a moon that orbits the Earth at an even quicker pace. To accurately predict the location that the moon will be in tomorrow at a particular time, one must take the sum of the movement of the Sun, the Earth and the moon cycles together. Forces, such as the planetary bodies, build upon one another and if we are able to derive the equivalents of the “Sun”, “Earth” and “moon” cycles of a stock price, or any other item or event, then similarly, future events relative to that item or event could be predicted and historical events could like wise be recalled. Although the various embodiments and aspects presented herein are primarily presented in view of predicting the future, it will be appreciated that predicting, recalling or verification of the past can also be an aspect of the various embodiments.

Thus, the various embodiments of the cyclic prediction machine as presented herein can generally be described as predicting future information about an item, process or event based on identifying or deriving the cyclic forces that affect the item or process. Again using the solar system example, deriving the Sun, Earth and moon cycle equivalents for the particular item, process or event of interest is how the various embodiments of the cyclic prediction machine operate. Within the present description, each of the relevant cycles is referred to as a level. In operation, the various embodiments begin with identifying the largest or most prominent influencing forces or cycles (i.e., the Sun) and then continue to ever decreasing levels (i.e., the Earth followed by the moon, etc.). There is no set limit as to how many levels down the various embodiments of the cyclic prediction machine can traverse or, the amount of data fed to the cyclic prediction machine. Rather, the number of levels or the depth of the analysis is determined by whatever is necessary to derive a useful result.

Turning now to the figures in which like labels represent like elements throughout the various views, the operation of exemplary embodiments of the cyclic prediction machine are presented. The various embodiments of the cyclic prediction machines may be described as performing three operations. The first operation is the generation of the solution levels. This process basically involves breaking down a historical curve representative of an event or item into one or more solution curves, each solution curve existing at a lower and lower level, or having less impact. In essence, the data represented in the original historical curve is extracted and stored within the plurality of solution curves, with a final curve representing a margin or error or, the remainder of the historical data that was not captured within a solution curve. The next process involves unpacking the data in the solution curves to verify the validity of the solution curves. This process is not mandatory for embodiments of the cyclic prediction machine but rather, may optionally be employed to provide data verification. The final process involves applying the solution curves that represent cyclical data that affects the item of concern, and using that information to project into the future or past and identify characteristics of the item of concern.

Generation of Solutions

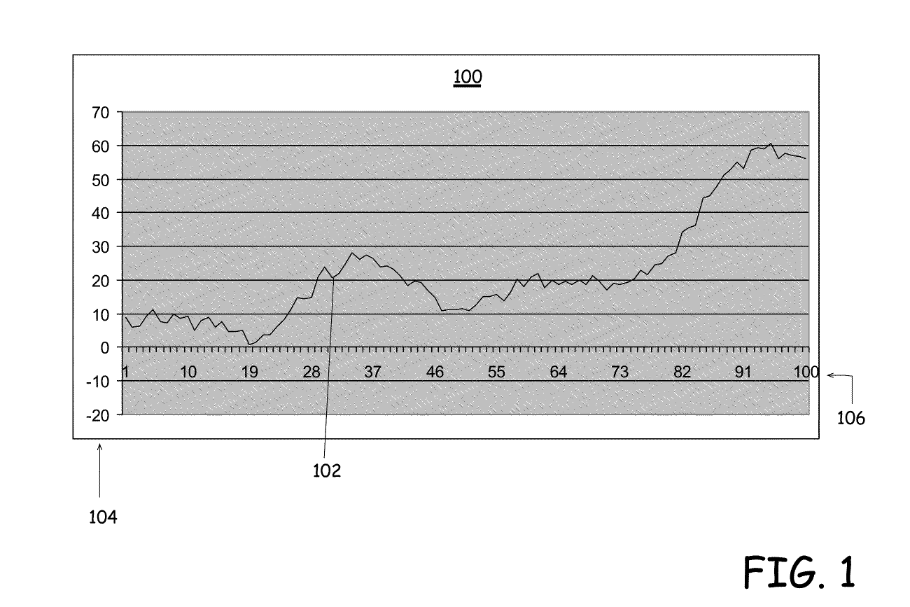

FIG. 1 is a graphic chart illustrating a characteristic change of an item over time, such as a particular era of time for the item. The chart can represent any of a variety of items, events, tendencies, etc. (collectively referred to as an item), such as an exemplary raw stock price history of what could be a random Fortune 500 stock. The chart 100 illustrates the historical fluctuations of the stock price as a curve 102 in which the curve reflects the value 104 of the stock price over a period of time or era 106. It should be appreciated that while most of the examples presented herein are illustrated as being based on time, other embodiments may operate based on some other changing variable such as speed, acceleration, heat, etc.

For the embodiment illustrated in FIG. 1, the exemplary period of time 106 is illustrated as including 100 time units, such as 100 days as a non-limiting example. The data curve 102 illustrated in FIG. 1 can operate as the level 1 input to an exemplary embodiment of a cyclic prediction machine. Thus, data representative of the data curve 102 could be fed or provided to the cyclic prediction machine in one or more of a variety of forms, including a digital stream, a graphic as illustrated, a table of points, etc. (collectively referred to as “chart data”). In response to receiving the level 1 input, the cyclic prediction machine may operate by identifying the overall trend of the chart data and generating trend data that is representative of this overall trend. The trend data, similar to the input data, can be represented in a variety of forms and formats, such as a digital stream, a plot, a table, etc. (collectively referred to as trend data). For purposes of brevity, the data input, generated and output from the cyclic prediction machine as described throughout this description, can be in any of the above-identified or other forms but will simply be referred to as data.

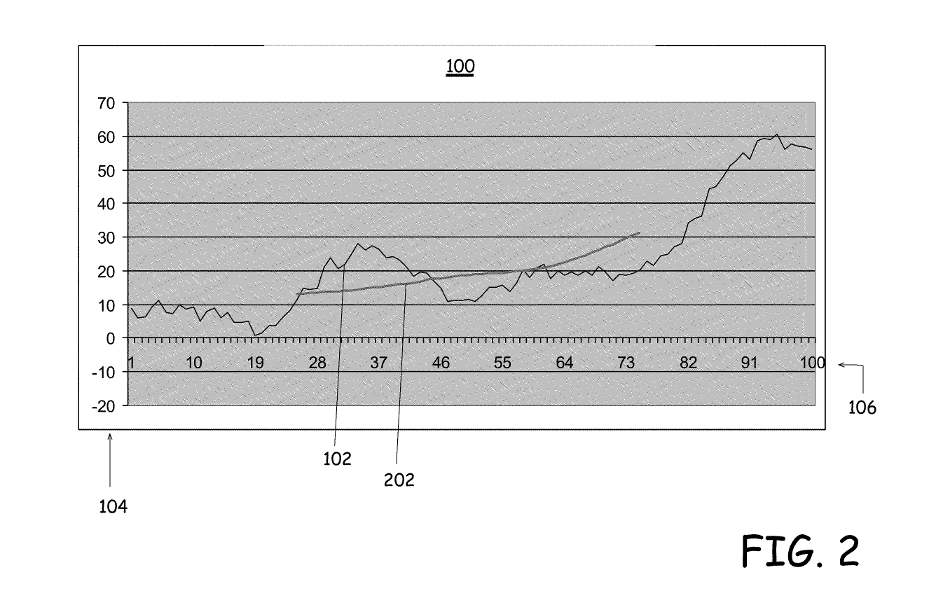

FIG. 2 is a graphic chart illustrating the results of an exemplary cyclic prediction engine operating on the level 1 input illustrated in FIG. 1 to generate the trend of the data. The exemplary cyclic prediction engine generates the curve 202 based on the level 1 data curve 102, which is referred to herein as the level 1 target 202. Returning to the illustration of the levels presented in view of the solar system, the level 1 data curve would represent the Sun curve, which basically means it represents the largest trend information in the data. It should be appreciated that the level 1 target is illustrated as being generated by calculating the average of the input curve over time. However, other techniques may also be employed including, but not limited to, identifying the mean curve, identifying the standard deviation, etc., as well as a combination of one or more such techniques. As an illustration, this would represent the Sun curve, which simply means the largest trend that can be derived from the data (i.e. the average curve of the data).

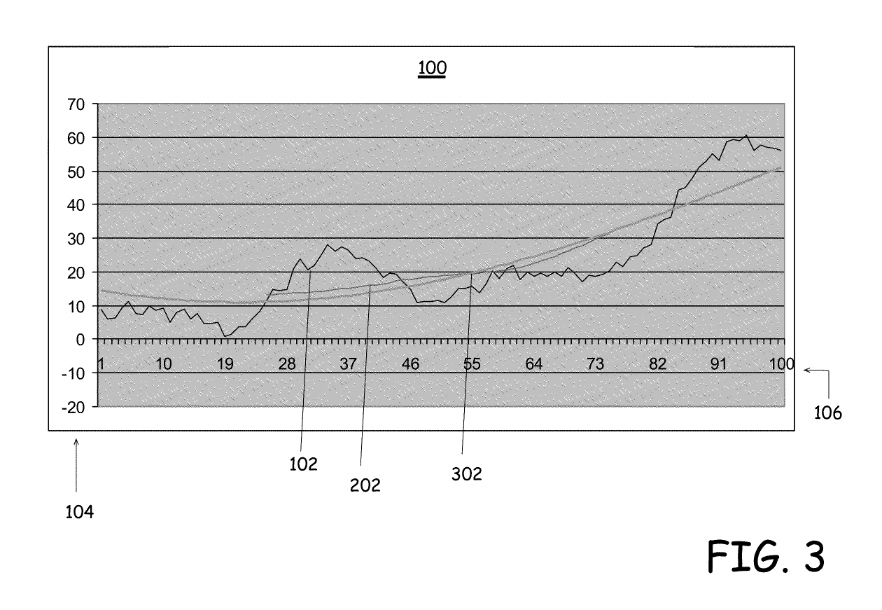

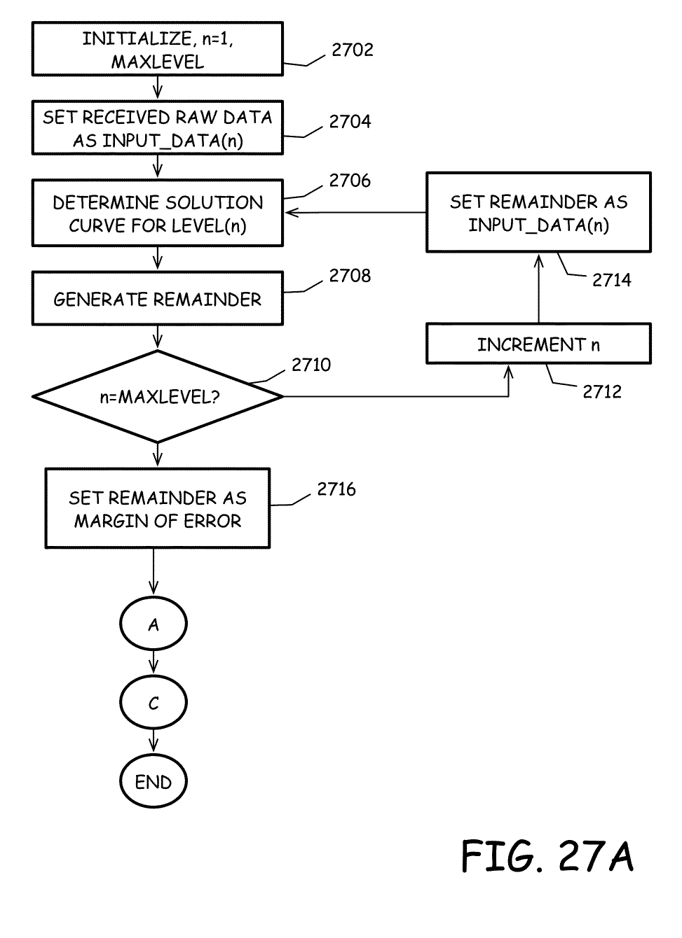

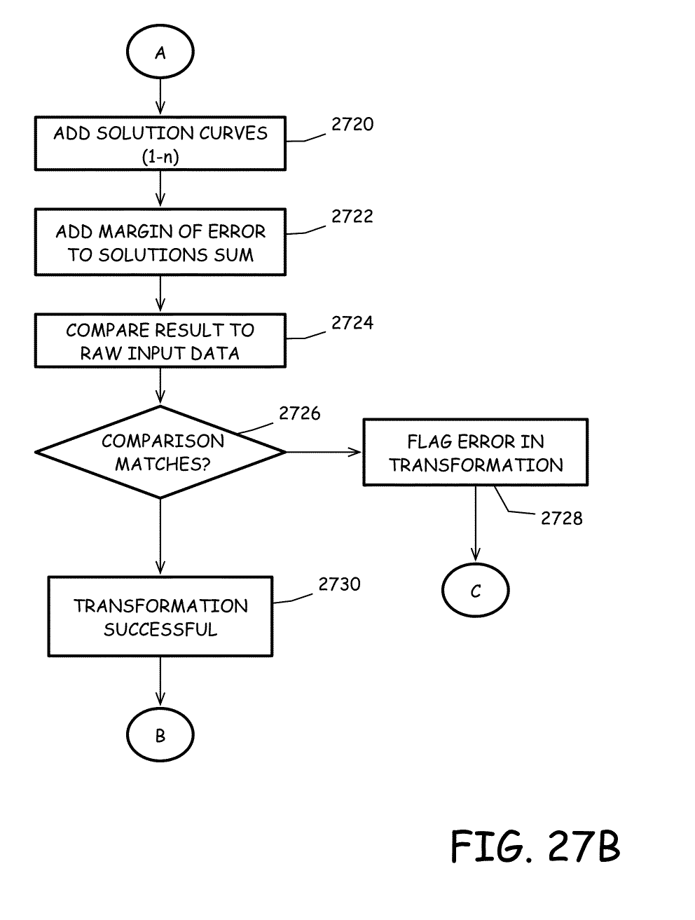

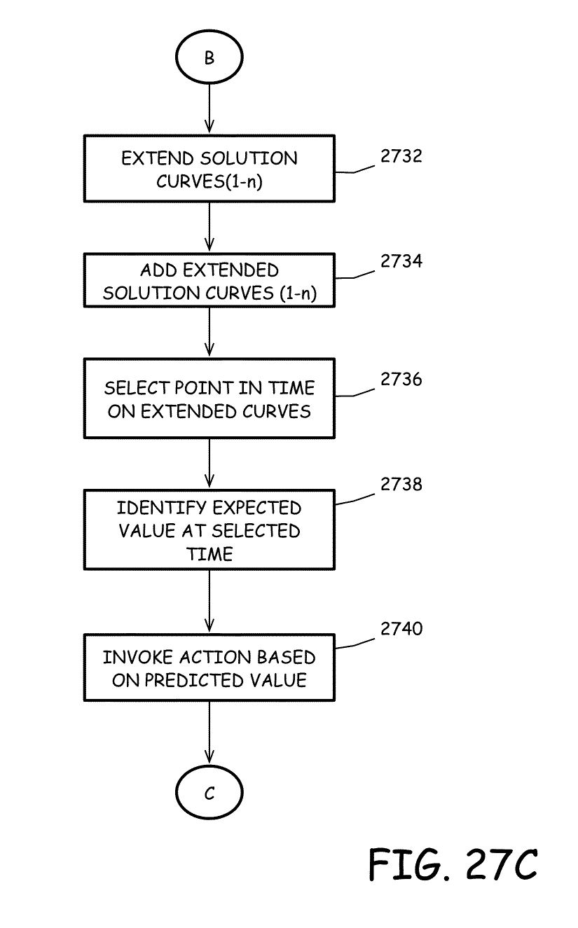

FIG. 3 is a graphic chart illustrating the generation of a level 1 solution by the cyclic prediction machine. In generating the level 1 solution, the cyclic prediction machine utilizes the level 1 target 202 as input to generate a continuous, cyclical curve 302 that is not bound in time and that closely resembles the level 1 target curve 202. Once the level 1 target curve 202 is processed by the cyclic prediction machine, the level 1 solution is complete. It should be appreciated that for each of the levels, this level and subsequent levels, the process of generating the target curve and the cyclical curve can be accomplished in a variety of manners. The description presented in conjunction with FIG. 27 presents various non-limiting techniques that could be employed. But in general, the cyclical curves can be generated by performing a mathematical computation or analysis over the entire domain of the raw input data or other input data or, only a portion of the input data to identify the cycle or curve and then project the curve across the domain and beyond.

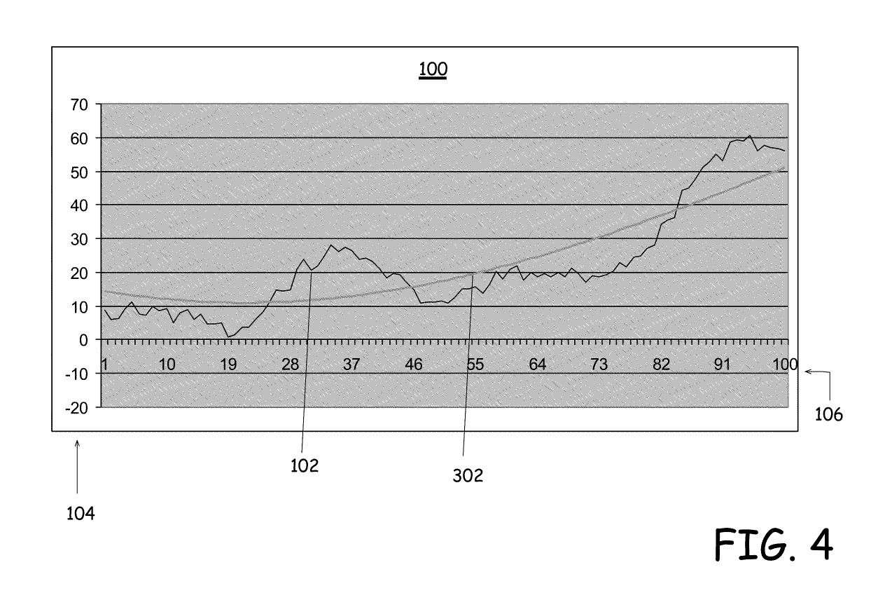

FIG. 4 is a graphic chart illustrating the level 1 solution overlaid with the level 1 raw data. Once the level 1 solution 302 has been generated, there is no longer a need for the level 1 target curve 202 as the cyclic prediction engine will perform further operations with the level 1 solution 302 and the knowledge of the level 1 raw data 102.

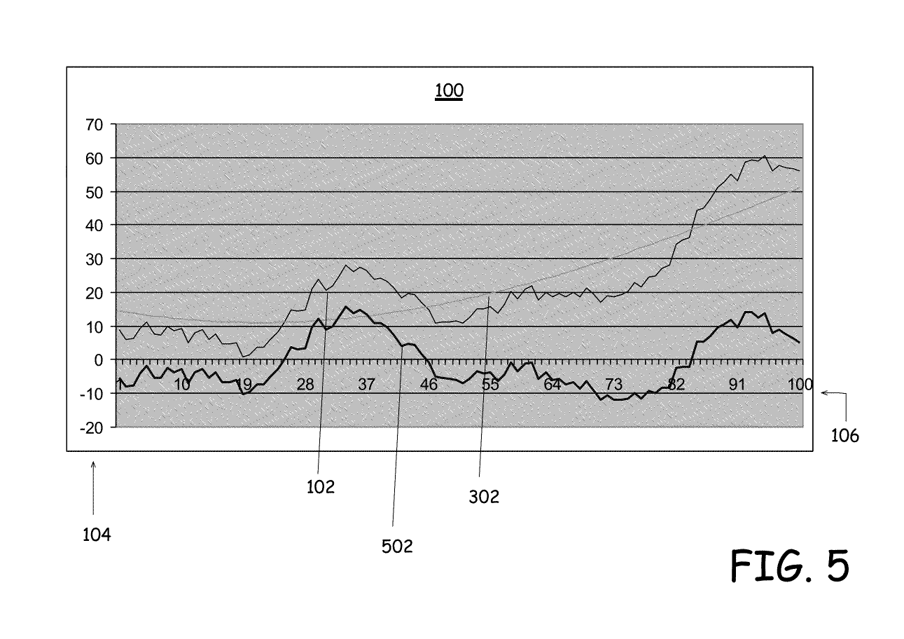

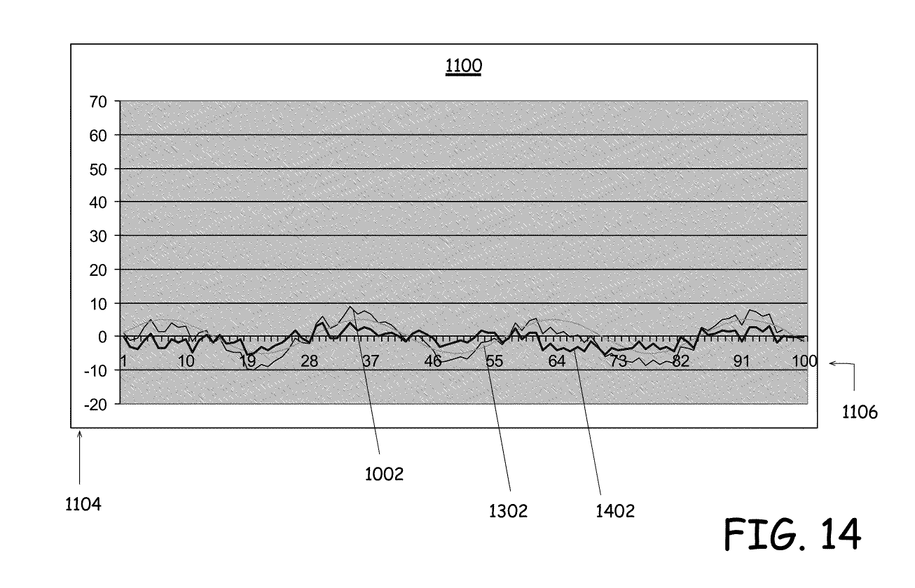

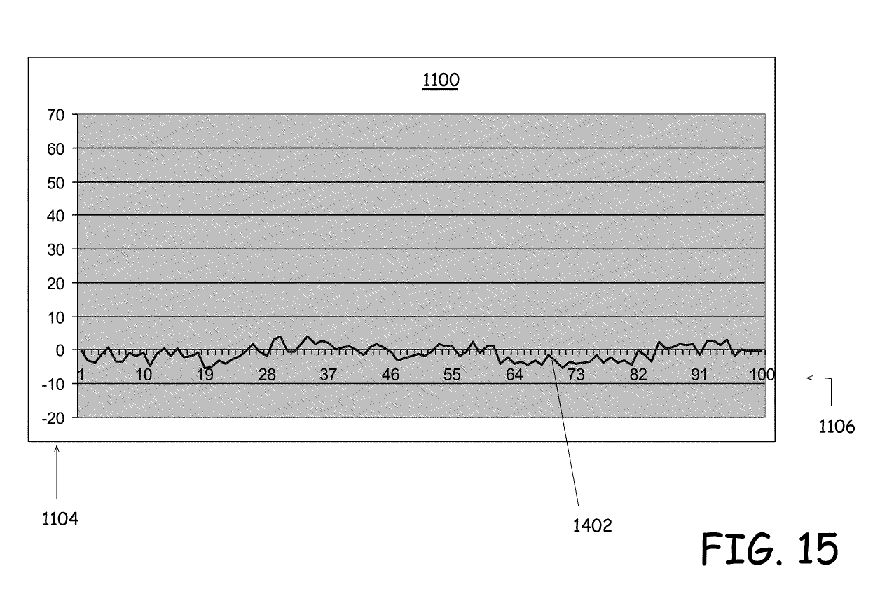

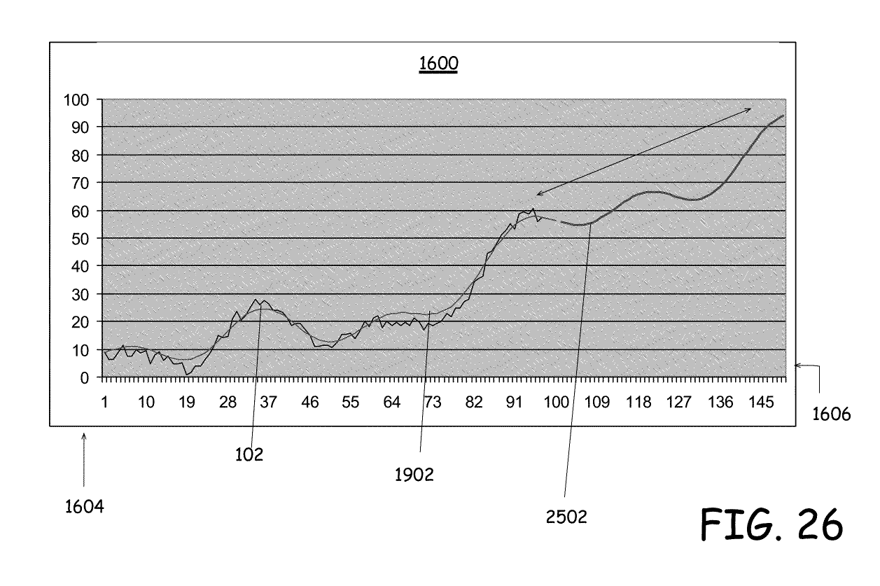

FIG. 5 is a graphic chart illustrating an output, or generated result, of the cyclic prediction machine in performing its final processing of the level 1 solution. With the level 1 solution cyclic curve 302 and the raw level 1 data 102, the cyclic prediction machine generates the data curve 502. The data curve 502 is generated in the illustrated example by subtracting the values of the raw level 1 data 102 and the level 1 cyclic curve 302. For purposes of the currently presented example, the data curve 502 represents a level 2 input to be fed back into the cyclic prediction machine. As will be described further with reference to FIGS. 14 and 15 describing the margin of error and FIG. 26, it will be appreciated that the data curve 502 generated at level 1, as well as other data curves generated at other levels by finding the difference between the solution curve and the input data curve can be viewed as a remainder. The remainder basically represents the data from the input that was not captured in the solution curve. The remainder can thus be a margin of error or, it can serve as input into the next level as is the case in this example. Once the level 2 input curve 502 is generated by the cyclic prediction machine, the level 1 cycle is complete.

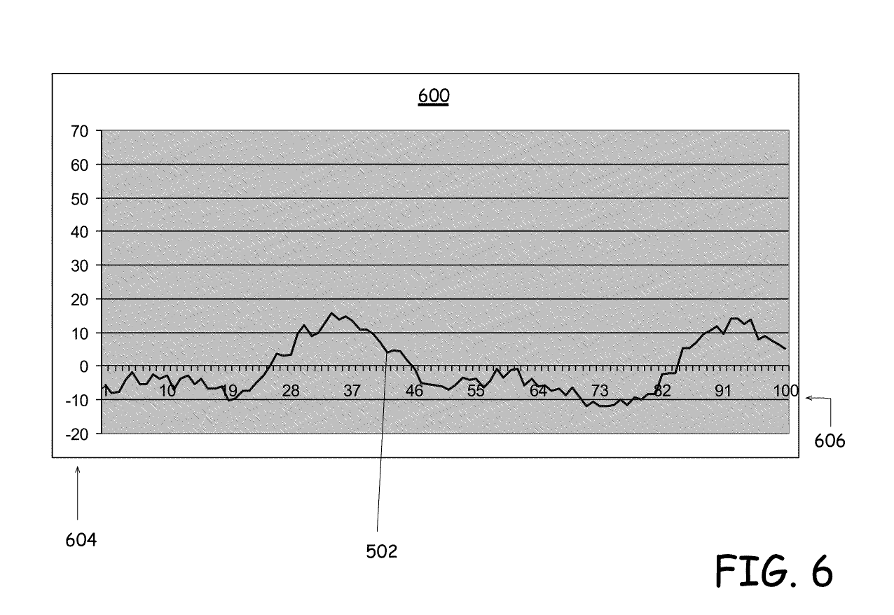

FIG. 6 is a graphic chart illustrating the first step in the level 2 processing by the cyclic prediction machine. The chart 600 illustrates the input level 2 data 502 over a period of 100 time units 606 with a range of values 604. The level 2 data is provided to or operated upon by the cyclic prediction machines.

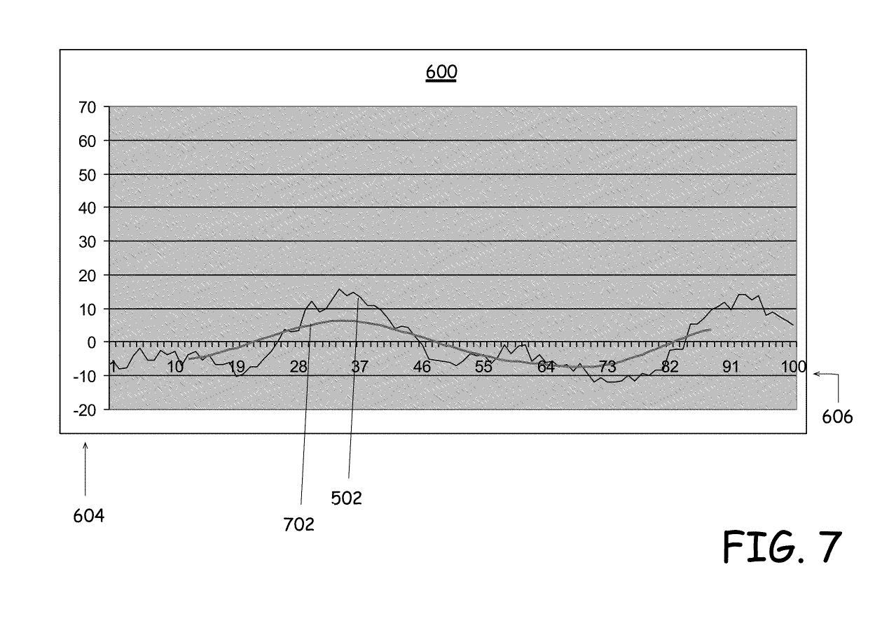

FIG. 7 is a graphic chart illustrating the results of an exemplary cyclic prediction engine operating on the level 2 input illustrated in FIG. 6 to generate the trend of the data. In response to receiving the level 2 input data 502, the cyclic prediction machine may operate by generating the overall trend of the level 2 data. As an illustration, this would represent the Earth curve, which simply means the next largest trend that can be derived from the data (i.e. the average curve of the data).

In processing the level 2 data curve 502, the exemplary cyclic prediction engine generates the curve based on the level 2 data curve 502. The generated curve is referred to herein as the level 2 target 702. It should be appreciated that the level 2 target 702 is illustrated as being generated by calculating the average of the input curve over time. However, other techniques may also be employed including, but not limited to, identifying the mean curve, identifying the standard deviation, etc. as well as a combination of one or more such techniques.

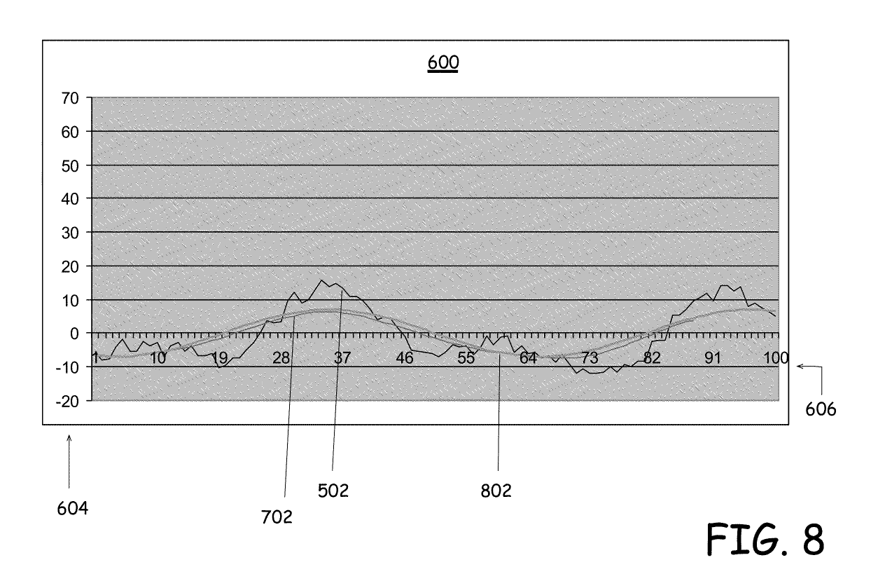

FIG. 8 is a graphic chart illustrating the generation of a level 2 solution by the cyclic prediction machine. The cyclic prediction machine utilizes the level 2 target 502 as input to generate a continuous, cyclical curve 802 that is not bound in time and that closely resembles the level 2 target curve 702. Once the level 2 target curve 802 is generated by the cyclic prediction machine, the level 2 solution is complete.

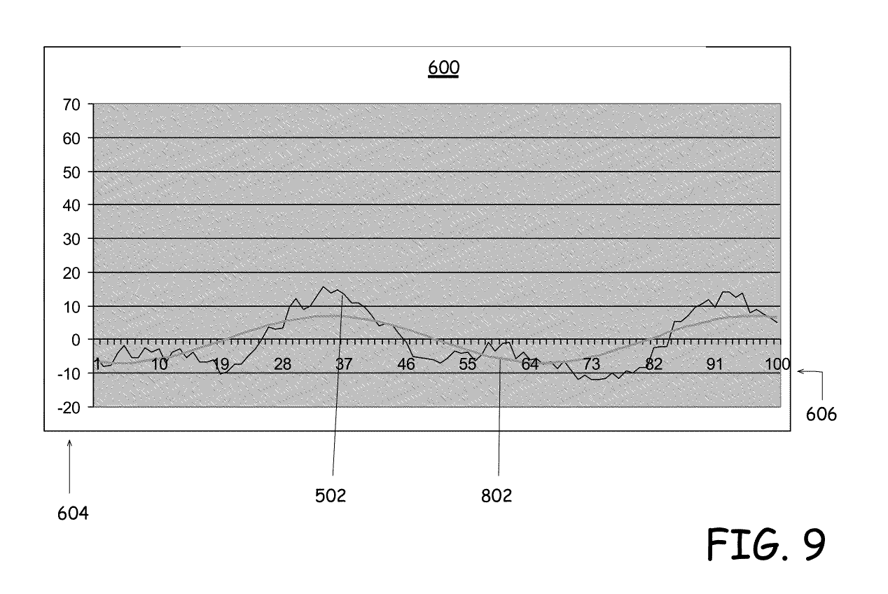

FIG. 9 is a graphic chart illustrating the level 2 solution overlaid with the level 2 input data 502. Once the level 2 solution 502 has been generated, there is no longer a need for the level 2 target curve 702 as the cyclic prediction engine will perform further operations with the level 2 solution and the level 2 input data 502.

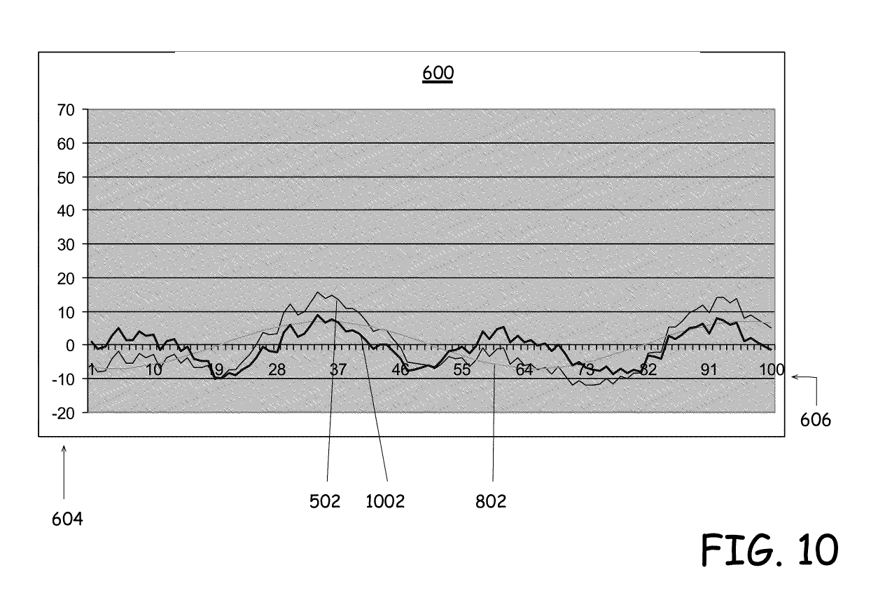

FIG. 10 is a graphic chart illustrating an output, or generated result, of the cyclic prediction machine in performing its final processing of the level 2 solution. With the level 2 solution cyclic curve 802 and the level 2 data 502, the cyclic prediction machine generates the data curve 1002. The data curve 1002 is generated in the illustrated example by subtracting the values of the level 2 input data 502 and the level 2 cyclic curve 802. For purposes of the currently presented example, the data curve 1002 represents a level 3 input to be fed back into the cyclic prediction machine. Once the level 3 input curve 1002 is generated by the cyclic prediction machine, the level 2 cycle is complete.

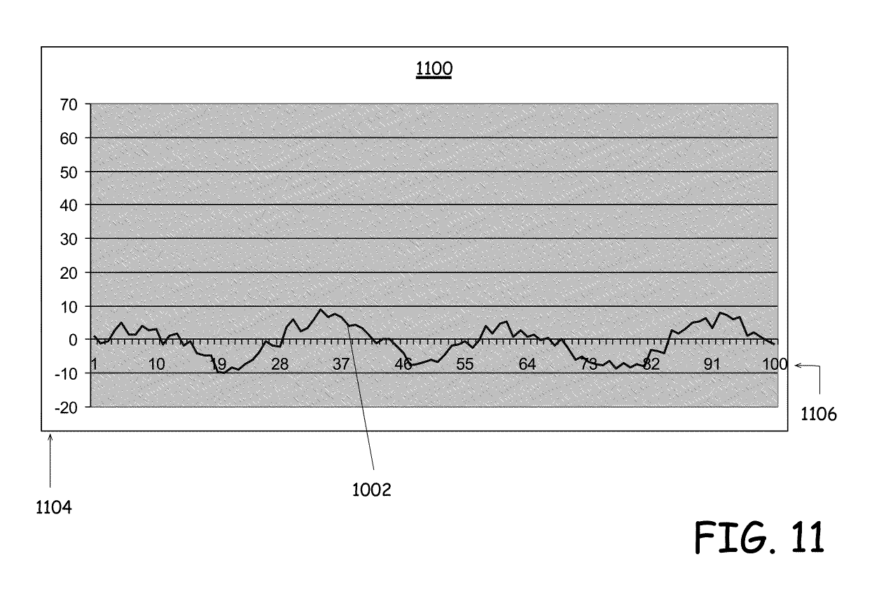

FIG. 11 is a graphic chart illustrating the first step in the level 3 processing by the cyclic prediction machine. The chart 1100 illustrates the input level 3 data 1002 over a period of 100 time units 1106 with a range of values 1104. The level 3 data is provided to, or operated upon by, the cyclic prediction machine. It being observed that the peaks and valleys in the level 3 input curve 1002 is less exaggerated then the level 2 input curve 502 and the level 1 raw data 106. As the cyclic prediction machine iterates through the various levels, the input curve will gradually grow smoother with less pronounced rises and falls. In response to receiving the level 3 input, the cyclic prediction machine may operate by generating the overall trend of the level 3 data. As an illustration, this would represent the moon curve, which simply means the next largest trend that can be derived from the data (i.e. the average curve of the data).

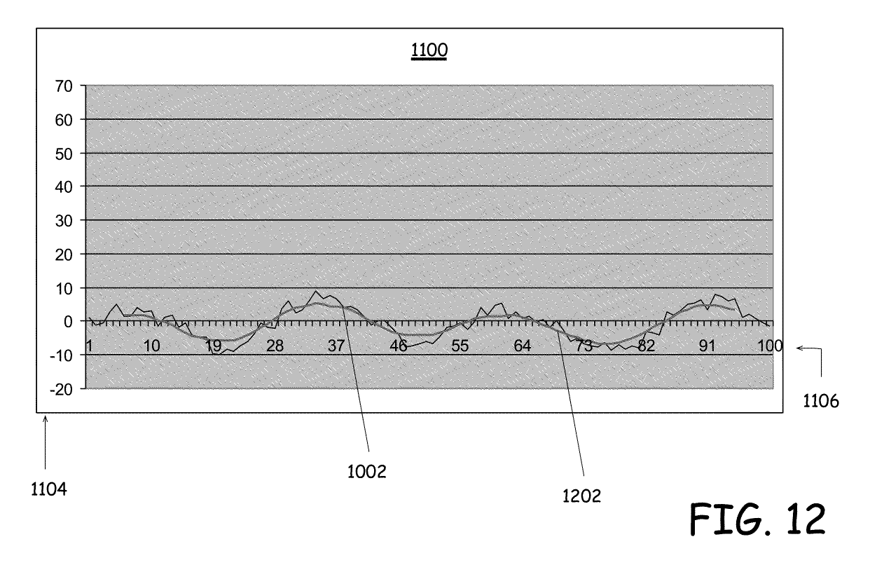

FIG. 12 is a graphic chart illustrating the results of an exemplary cyclic prediction engine operating on the level 3 input illustrated in FIG. 11 to generate the trend of the data. In response to receiving the level 3 input data 1002, the exemplary cyclic prediction engine may operate by generating the overall trend of the level 3 data. The curve 1202 is based on the level 3 input data curve 1002, which is referred to herein as the level 3 target 1202. In should be appreciated that the level 3 target is illustrated as being generated by calculating the average of the input curve over time. However, other techniques may also be employed including, but not limited to, identifying the mean curve, identifying the standard deviation, etc., as well as combinations of two or more such techniques.

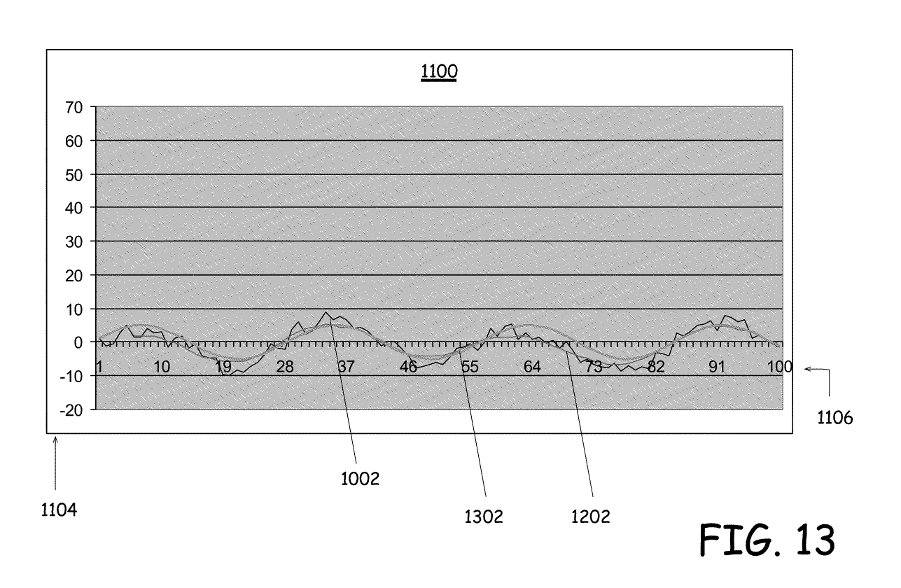

FIG. 13 is a graphic chart illustrating the generation of a level 3 solution by the cyclic prediction machine. The cyclic prediction machine then utilizes the level 3 target 1202 as input to generate a continuous, cyclical curve 1302 that is not bound in time and that closely resembles the level 3 target curve 1202. Once the level 3 target curve 1302 is generated by the cyclic prediction machine, the level 3 solution is complete. As an illustration, the level 3 solution would represent the moon curve in the solar system illustration, which simply means the next largest trend that can be derived from the data (i.e. the average curve of the data).

FIG. 14 is a graphic chart illustrating the level 3 solution overlaid with the level 3 input data and the resulting data curve after processing the level 3 solution and input data. Once the level 3 solution has been generated, there is no longer a need for the level 2 target curve 1202 as the cyclic prediction engine will perform further operations with the level 3 solution.

FIG. 14 also illustrates the generated output, or generated result, of the cyclic prediction machine in performing its final processing of the level 3 solution. With the level 3 solution cyclic curve 1302 and the level 3 data 1002, the cyclic prediction machine generates the data curve 1402. The data curve 1402 is generated in the illustrated example by subtracting the values of the level 3 input data 1002 and the level 3 cyclic curve 1302. For purposes of the currently presented example, the data curve 1402 represents a margin of error for the final processing of the cyclic prediction machine but, if further processing levels are desired, the data curve 1402 could represent the level 4 input to be fed back into the cyclic prediction machine. Once the margin of error curve 1402 is generated by the cyclic prediction machine, the level 3 cycle is complete.

FIG. 15 is a graphic chart illustrating the output from the level 3 processing 1402. As previously mentioned, this curve 1402 could operate as input for level 4 processing or, if no further accuracy or levels of processing are desired, the curve 1402 operates as the margin of error for the cyclic prediction machine. Again, it can be observed that the peaks and valleys in data curve 1402 are less exaggerated then the level 3 input curve 1002, the level 2 input curve 502 and the level 1 raw data 102. As the cyclic prediction machine iterates through the various levels, the input curve will gradually grow smoother with less pronounced rises and falls.

The margin of error can be viewed as the data “that got away”. The margin of error represents all of the data from the original raw data curve that did not get captured in one of the solution levels. The more levels that are fed through the cyclic prediction machine, the more details and data can be captured. However, for purposes of illustration, the presented example only shows a traversal of three levels. As the margin of error approaches a smooth flat line, more and more of the data is captured in the process. Thus, if a sufficient number of levels are iterated with the cyclic prediction machine, the margin of error curve will approach a flat line. It is desirable to have a smooth margin of error curve in that it indicates that a majority of the data has been captured within set of solution curves.

Unpacking the Solution Curves

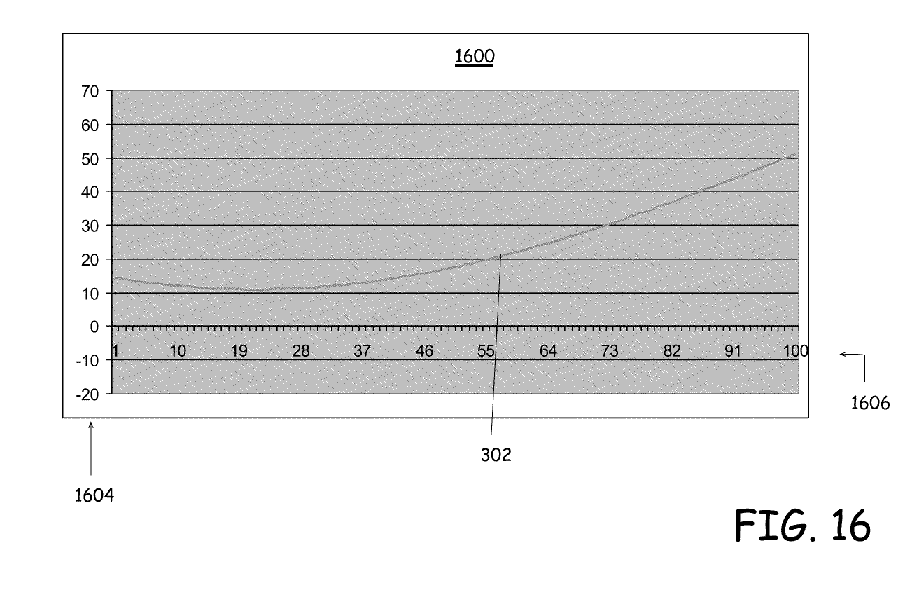

The solution curves generated for each level combine to form a solution set. FIG. 16-FIG. 21 are graphic charts illustrating the reverse operation of the generation of the solutions to derive the original data. This process does not have to be performed by the cyclic prediction machine may be performed to verify the integrity of the date.

FIG. 16 is a graphic chart illustrating the level 1 solution curve 302. As the reader will recall, the level 1 solution curve was generated by identifying the trend of the raw level 1 data to generate a curve, such as the average value of the data over time.

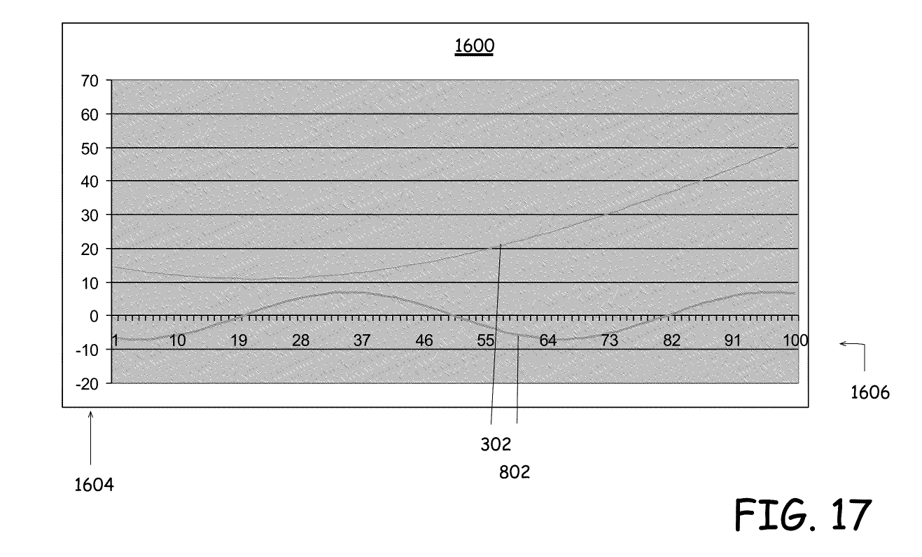

FIG. 17 is a graphic chart illustrating the level 1 solution curve 302 along with the level 2 solution curve 802.

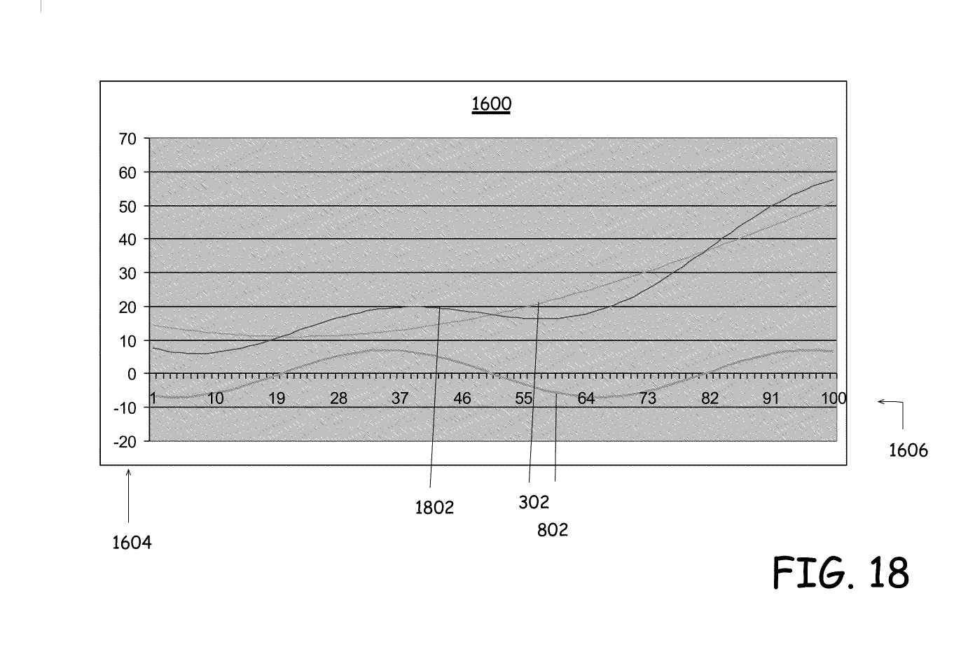

FIG. 18 is a graphic chart illustrating a resulting data curve created by combining the level 1 solution curve 302 with the level 2 solution curve 802. The data curve 1802 is generated simply by adding the two solution curves together.

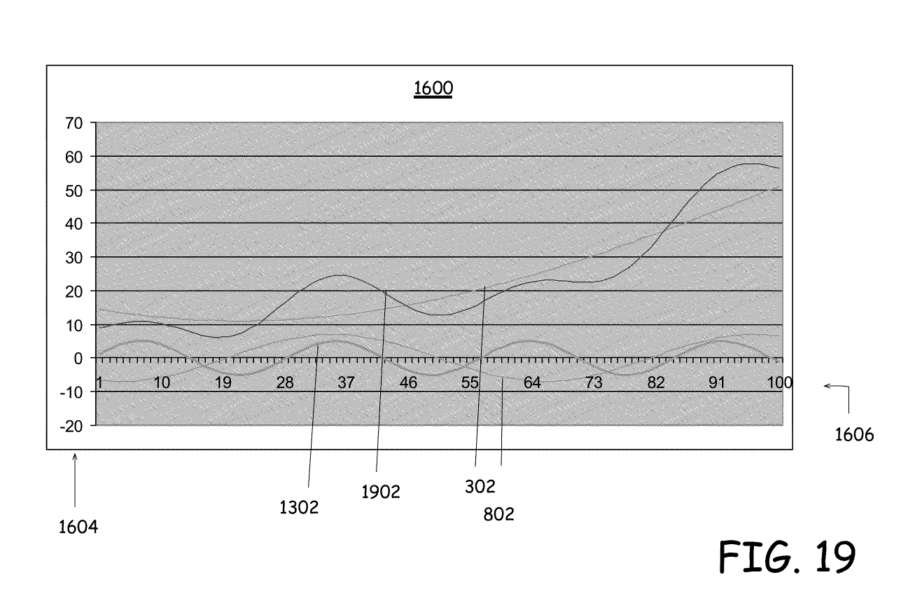

FIG. 19 is a graphic chart illustrating a resulting data curve when all the entire solution set is added together. The level 1 solution 302, the level 2 solution 802 and the level 3 solution 1302 are illustrated together on the same time-line. When the three solutions are combined, such as by adding them together, the resulting data curve 1902 is generated.

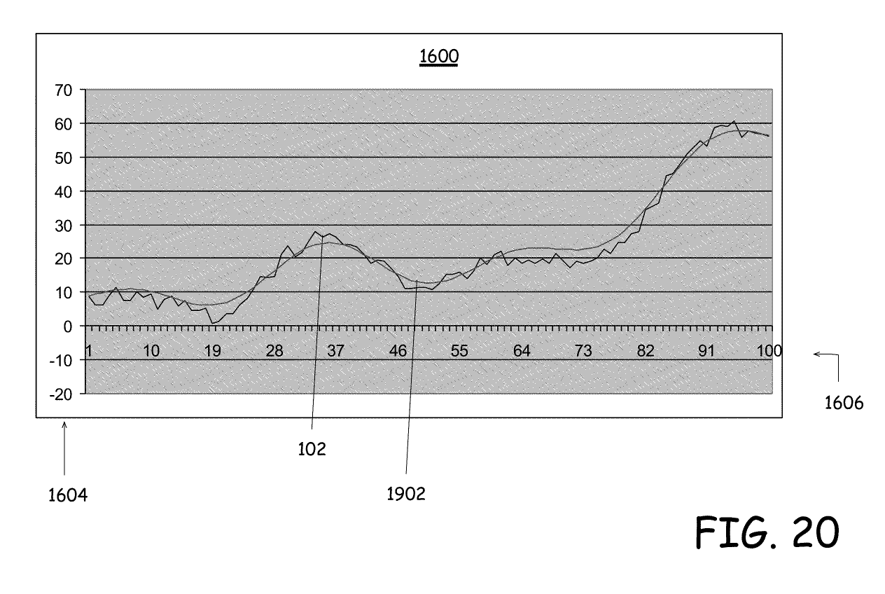

FIG. 20 is a graphic chart illustrating an overlay of the original raw level 1 input data with the resulting data curve of FIG. 19. It will be appreciated that the data curve 1902 is a combination of each of the three solutions from level 1, level 2 and level 3. As the reader will recall, each of the solution curves effectively include the storage of the original historical data. Thus, as the solutions are added together, it is shown that the resulting data curve 1902 closely resembles the original raw level 1 input curve 102.

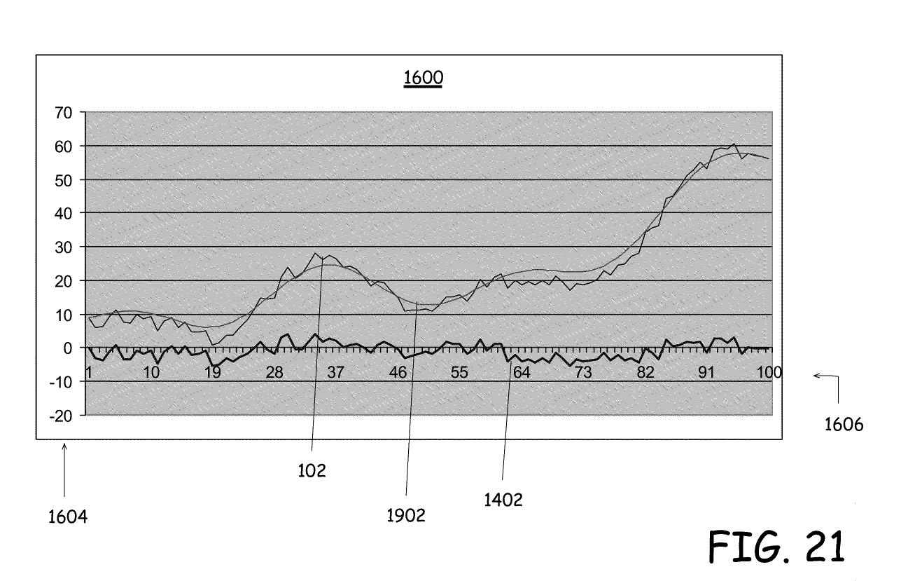

FIG. 21 is a graphic illustration of the relationship between the resulting data curve from combining the three solutions and the original raw data curve. As can be seen in FIG. 21, if the difference between the combined data curve 1902 and the original raw data curve 102 is determined, the different is illustrated as the margin of error curve 1402 that was illustrated in FIG. 15. Thus, if one added the combined solution curve 1902 with the margin of error curve 1402, the original raw data curve 102 is generated without any loss of data. It can thus be concluded that the cyclic prediction machine has in essence, successfully modeled a given stock price less the margin of error.

Predicting Values at Different Points in Time

Given the afore-described groundwork, the next process of the cyclic prediction machine is to actually predict a future event, activity or value. To understand how the cyclic prediction machine operates to predict the future, the curves presented in FIG. 19 are once again examined. The level 1 solution 302, the level 2 solution 802 and the level 3 solution 1302 are all combined to generate a single curve representing the solution set 1902. As the reader will recall, the level solutions are not bound by time and as such, the curves can be projected forward.

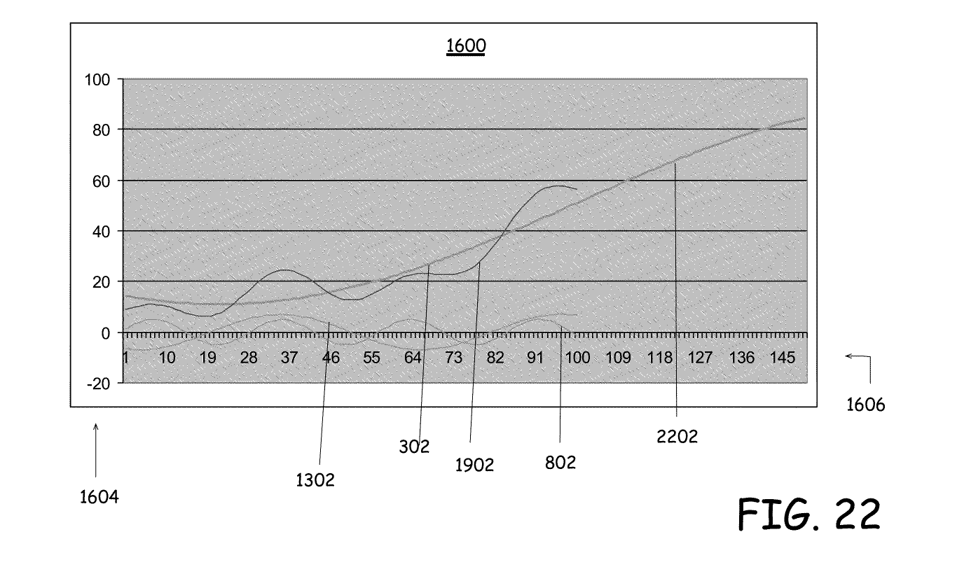

FIG. 22 is a graphic illustration of the solution curves for level 1-3 with the level 1 solution curve being projected or extended forward. The level 1 solution curve 302 is shown, as presented in FIG. 4, along the time axis 1606 between time point 1 and time point 100. As previously mentioned, the solution curves are not bound by time and as such, the level 1 solution curve 302 is extended. The time frame from point 1 to point 100 is considered to represent historical time. The points on the time line above point 100 are considered to represent future time. After time point 100, the projected portion of the level 1 solution curve is further extended in time 2202.

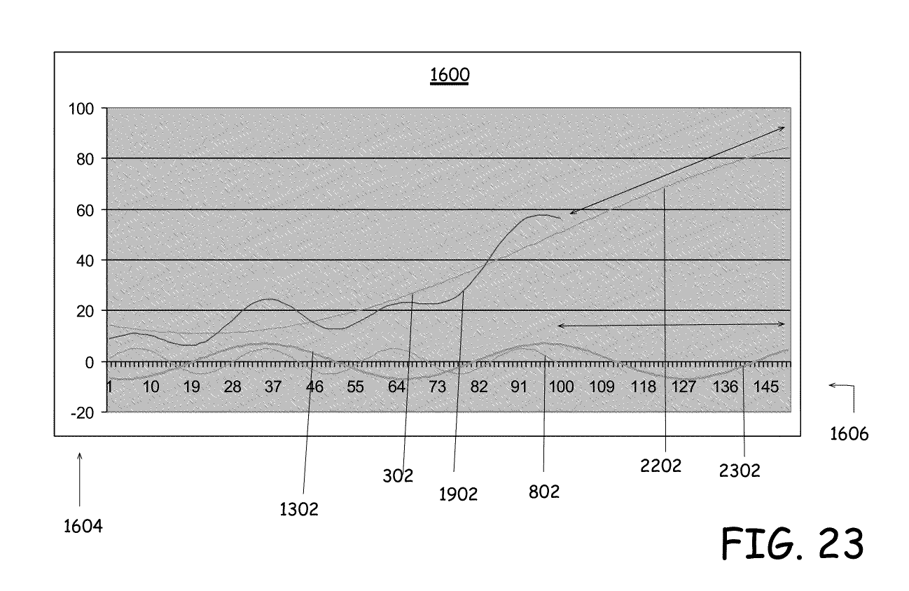

FIG. 23 is a graphic illustration of the solution curves for level 1-3 with the level 1 and level 2 solution curves being extended forward in time. The level 2 solution curve 802 is shown between time points 1 and 100 as presented in FIG. 8. The extension of the level 2 solution 2302 is the projected portion of the level 2 solution curve 802 after the time point 100 in FIG. 23.

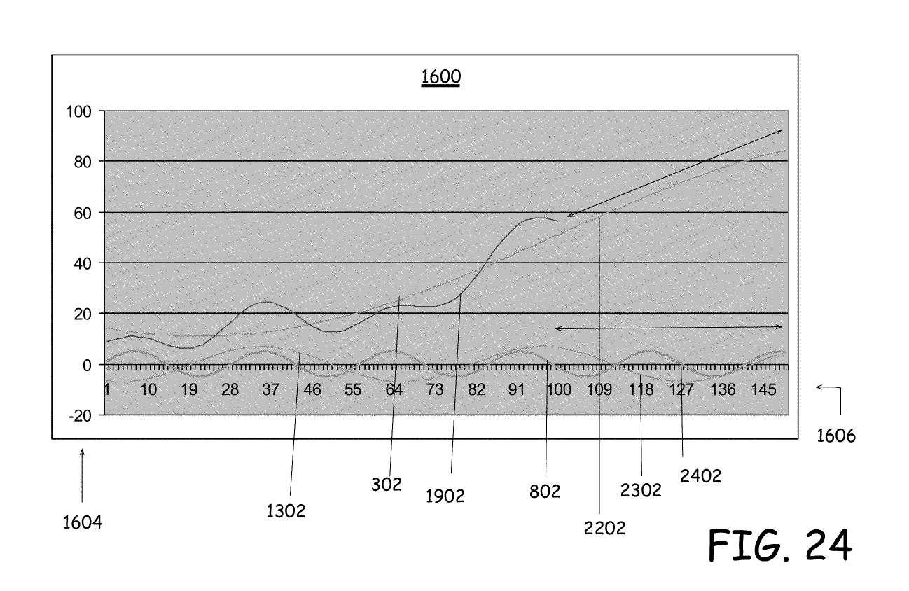

FIG. 24 is a graphic illustration of the solution curves for level 1-3 with the level 1, level 2 and level 3 solution curves being extended forward in time. The level 3 solution curve 1302 is shown between time points 1 and 100 as presented in FIG. 13. The extension of the level 3 solution 2402 is the projected portion of the level 3 solution curve 1302 after the time point 100 in FIG. 24.

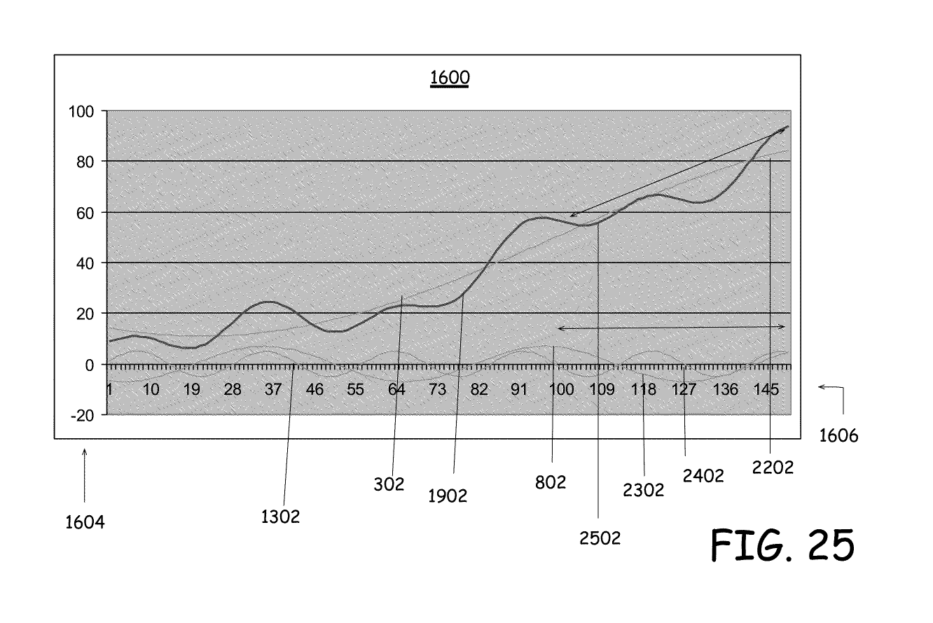

FIG. 25 is a graphic illustration of the extended solution curves for level 1-3 being combined. Because the extended solution curves are just extension of the previously generated solution curves, they can simply be combined or added together to generate an extended combination of the level solution curves. As such, combining the level 1 solution 302 with extension 2202, level 2 solution 802 with extension 2302 and level 3 extension 1302 with extension 2402 results in the combined data curve 1902 as depicted in FIG. 19 and the extension thereof 2502. It will be appreciated then that the extended portion 2502 of data curve 1902 includes future predicted values for the item represented by the historical raw data 102.

FIG. 26 is a graphic chart illustration of the extended combined data curve along with the historical raw data curve for the item being evaluated. Thus, the solution set was derived from the cyclical curves of an item or event, such as a stock price for a particular stock. Furthermore, the curves represent various forces acting upon that item, such as the stock price in our example. Relying on the assumption that everything in life cycles, including forces, it is then assumes that these forces will continue to cycle into the future. As a result, the extension 2502 of the data curve 1902 is thus an output from the cyclic prediction machine that predicts the future characteristics of the item or event being evaluated—in the particular example, the price of the stock.

FIGS. 27A-27C is a flow diagram illustrating the exemplary actions taken by an exemplary cyclic prediction machine. These actions have been represented graphically in FIGS. 1-26 but are now illustrated as actions that the cyclic prediction machine takes in the conversion of raw data into data curve representing a future prediction of attributes of the item being evaluated based on cyclical historical data. It should be appreciated that embodiments of the cyclic prediction engine can be used to predict a variety of attributes for a variety of items or events and although particular examples pare presented herein, these examples are non-limiting examples provided for the purpose of illustration. However, it will also be appreciated that the particular examples presented herein may also constitute novel inventions and/or variations of the general invention presented within this disclosure. The process can be implemented in software or hardware, as well as a combination of both. In a software implementation, the actions are constructed of software program steps that are interpreted and performed by a processing unit that can also receive inputs and provide outputs. The software and/or hardware configuration constitute and embodiment of the cyclic prediction machine.

Looking more closely at FIG. 27A, at the onset, an initialization process 2702 is performed in which necessary variables are set and established, as well as any constants or thresholds. In the exemplary embodiment, the variable “n” which represents the current level of processing that is taking place is initially set to a value of “1”. In addition, the maximum number of levels to be included in the operation of the cyclic prediction machine is set to a value of MAXLEVEL.

The cyclic prediction machine can then either receive, retrieve, read, etc., a set of raw data and establishes the raw data as the level n input (INPUT DATA(n)) 2704. For the raw data, the input level is typically n=1.

The raw data is then processed by the cyclic prediction machine to determine or generate a solution curve for the current level (SOLUTION CURVE LEVEL(n)) 2706.

The solution curve can be determined or generated in a variety of manners but in general, the input data is analyzed and used to generate the solution curve. This can be referred to as determining the trend of the input data. This can be accomplished in any one or more of a variety of ways and in essence, can be viewed as an averaging or curve smoothing process. A simple technique for smoothing signals or curves, such as the raw data curve or any input data curve is calculating a moving average. Using this technique, an array of raw (noisy) data [y₁, y₂, . . . , y_{N}] can be converted to a new array of smoothed data. The “smoothed point” (Yₖ)s is the average of an odd number of consecutive 2n+1 (n=1, 2, 3, . . . ) points of the raw data Yₖ₋ₙ, Yₖ₋ₙ₊₁, . . . , Yₖ₋₁, Yₖ, Yₖ₊₁, . . . , Yₖ₊ₙ₋₁, Yₖ₊ₙ, i.e.

$${( {y}_{k} )}_{s} = {\sum }_{i = - n}^{i = n} {y}_{k + i} / ( 2 n + 1 )$$

The odd number 2n+1 is usually referred to as the filter width. The greater the filter width the more intense is the smoothing effect. For instance, assume an example that has a filter width of 5. The first five raw data points within the curve are averaged and their average value is plotted as the solution curve at the corresponding point “n”. The value of n is increased and points 2 through 6 are averaged, and the average is plotted as a smoothed data point in the solution curve, and so on. This procedure is called a 5-point unweighted smooth.

Another technique is to perform a least squares fit of a small set of consecutive data points to a polynomial and take the calculated central point of the fitted polynomial curve as the new smoothed data point. Savitzky and Golay showed that a set of integers (A-n, A-(n−1) . . . , An−1, An) could be derived and used as weighting coefficients to carry out the smoothing operation. The use of these weighting coefficients, known as convolution integers, turns out to be exactly equivalent to fitting the data to a polynomial, as just described and it is computationally more effective and much faster. Therefore, the smoothed data point (yk)s by the Savitzky-Golay algorithm is given by the following equation:

$${( {y}_{k} )}_{s} = \frac{{\sum }_{i = - n}^{n} {A}_{i} {y}_{k + i}}{{\sum }_{i = - n}^{n} {A}_{i}}$$

Many sets of convolution integers can be used depending on the filter width and the polynomial degree. Typical sets of these integers for “quadratic smooth” are shown in the table below:

Filter width (2n + 1)

| i | 11 | 9 | 7 | 5 |
|---|---|---|---|---|
| −5 | −36 | | | |
| −4 | 9 | −21 | | |
| −3 | 44 | 14 | −2 | |
| −2 | 69 | 39 | 3 | −3 |
| −1 | 84 | 54 | 6 | 12 |
| 0 | 89 | 59 | 7 | 17 |
| 1 | 84 | 54 | 6 | 12 |
| 2 | 69 | 39 | 3 | −3 |
| 3 | 44 | 14 | −2 | |
| 4 | 9 | −21 | | |
| 5 | −36 | | | |

Sets of convolution integers can be used to obtain directly, instead of the smoothed signal, its 1st, 2nd, . . . , mth order derivative, therefore Savitzky-Golay algorithm is very useful for calculating the derivatives of noisy signals consisting of discrete and equidistant points.

The smoothing effect of the Savitzky-Golay algorithm is not so aggressive as in the case of the moving average.

In ensemble average, successive sets of data are collected and summed point by point. Therefore, a prerequisite for the application of this method is the ability to reproduce the signal as many times as possible starting always from the same data point.

Yet another technique is simply to interpolate between two adjacent points, with the points selected at a level of granularity, to identify a mean or average. Other techniques may also be used and are anticipated.

Upon determination or generation of the solution curve, the difference between the solution curve and the INPUT_DATA(n) can be determined to generate the remainder 2708.

Once the SOLUTION CURVE FOR LEVEL(n) is determined 2706 and the remainder extracted 2708, the cyclic prediction machine determines if the last level has been processed 2710. If n is not equal to the MAXLEVEL, then the next action is to increment the value of n 2712 and then set the remainder to the INPUT_DATA(n) 2714. The operation of the cyclic prediction machine then returns to action 2706 to determine the solution curve for the new input data.

However, if the last level has been processed (i.e., n=MAXLEVEL) 2710, then the MARGIN OF ERROR is set to the value of the remainder and operation of the cyclic prediction machine continues at point A in FIG. 27B to verify the integrity of the solutions. It should be noted that the actions taken to verify the integrity of the solution may be optional and thus, not included in certain embodiments of the cyclic prediction machine.

FIG. 27B is a flow diagram depicting exemplary actions in a solution data integrity check that may be included in various embodiments of the cyclic prediction machine. Initially, each of the solution curves for each of the levels 1-n are combined, such as being added together or otherwise joined together in a manner that is commensurate with the technique used to generate the solution curves as presented in conjunction with action 2706.

The MARGIN OF ERROR can then also be combined into the combined solution curves 2722. At this point, the combined solution curves and margin of error can be compared to the raw input data 2724. The results of this comparison should be a match. If the comparison does not match 2726, an error in the transformation is flagged and the operation resumes at point C in FIG. 27A where the process terminates or, can be restarted, rechecked, etc.

If the comparison matches 2726, leaving some room for data loss, the transformation is deemed successful 2730 and, processing continues at point B in FIG. 27C.

FIG. 27C is a flow diagram depicting exemplary actions in the future prediction operation of an exemplary embodiment of a cyclic prediction machine. Based on the shape of the solution curves generated in action 2706, the curves are extended into the time domain to a future point in time 2732. In some situations, the solution curves may be extended simply by repeating the cyclic pattern of the solution curve. For instance, if the solution curve is sinusoidal, the solution can be extended by repeating the patter at the same duty cycle and amplitudes. If the solution curve on the other hand is parabolic, the extension may simply be a further projection of the curve over time.

Once the solution curves are sufficiently extended to a point at least at which a prediction is to be made, the extended solution curves can be combined, such as by adding the curves or combining in another fashion 2734. Once the curves are combined, the predicted curve is available for analysis. A particular point in time can be selected 2736 and identified on the combined extended solution curves and the corresponding value can be identified 2738. Finally, an action can be invoked based on the predicted value 2740. The action can be any of a variety of actions such as, the cyclic prediction machine initiating an e-commerce transaction, evaluating the retrieved value in view of other data related to a consumer's buy/sell requirements for a stock portfolio and triggering an transaction, generating an alert message based on the retrieved value compared with a list of alert notification requirements, as well as a wide variety of other actions. The actions can include sending messages (i.e., email, SMS, MMS, etc.), turning equipment on or off, sounding alarms, actuating other mechanisms, initiating transactions such as through e-commerce or the internet, etc. Once the optional action is invoked, the operation returns to point C in FIG. 27 A where the process either terminates or restarts.

It will be appreciated that although the various embodiments have been described as being beneficial to predict the future, or future events or characteristics pertaining to the item of interest, the solution curves can just as easily be extended backwards in time to identify historical characteristics related to the item that may not be available other wise or, simply for verification.

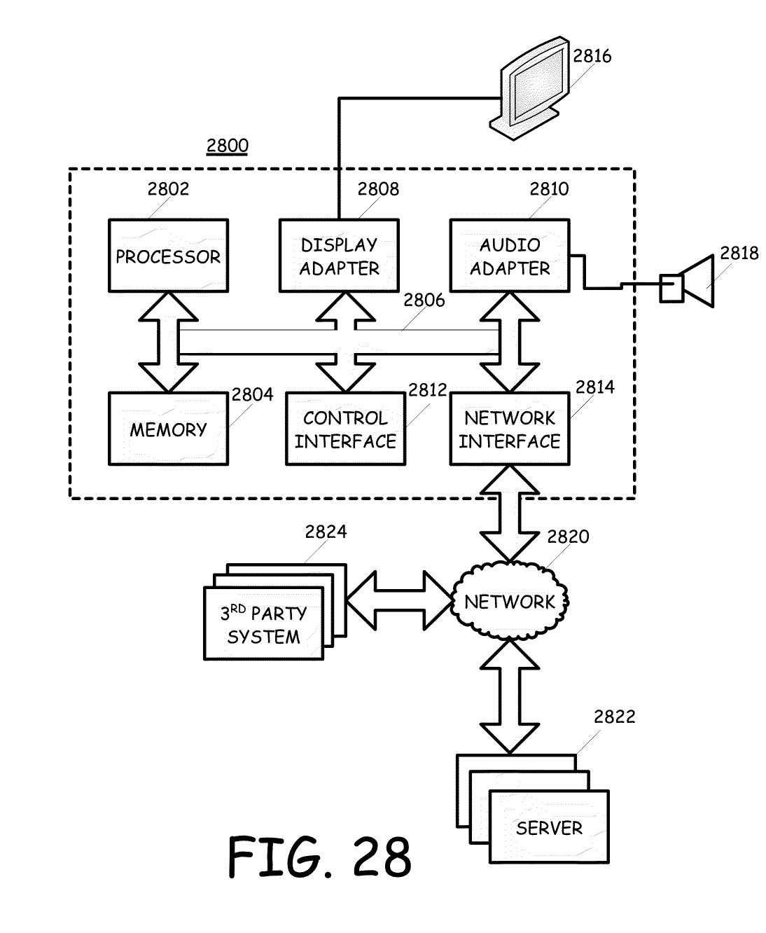

FIG. 28 is a functional block diagram of the components of an exemplary embodiment of system or sub-system operating as a controller or processor 2800 that could be used in various embodiments of the disclosure for controlling or implementing various aspects of the various embodiments or various embodiments of the cyclic prediction machine. It will be appreciated that not all of the components illustrated in FIG. 28 are required in all embodiments but, each of the components are presented and described in conjunction with FIG. 28 to provide a complete and overall understanding of the components. The controller can include a general computing platform 2800 illustrated as including a processor/memory device 2802/2804 that may be integrated with each other or, communicatively connected over a bus or similar interface 2806. The processor 2802 can be a variety of processor types including microprocessors, micro-controllers, programmable arrays, custom IC's etc. and may also include single or multiple processors with or without accelerators or the like. The memory element of 2804 may include a variety of structures, including but not limited to RAM, ROM, magnetic media, optical media, bubble memory, FLASH memory, EPROM, EEPROM, etc. The processor 2802, or other components in the controller may also provide components such as a real-time clock, analog to digital convertors, digital to analog convertors, etc. The processor 2802 also interfaces to a variety of elements including a control interface 2812, a display adapter 2808, an audio adapter 2810, and network/device interface 2814. The control interface 2812 provides an interface to external controls, such as sensors, actuators, drawing heads, nozzles, cartridges, pressure actuators, leading mechanism, drums, step motors, a keyboard, a mouse, a pin pad, an audio activated device, as well as a variety of the many other available input and output devices or, another computer or processing device or the like. The display adapter 2808 can be used to drive a variety of alert elements 2816, such as display devices including an LED display, LCD display, one or more LEDs or other display devices. The audio adapter 2810 interfaces to and drives another alert element 2818, such as a speaker or speaker system, buzzer, bell, etc. The network/interface 2814 may interface to a network 2820 which may be any type of network including, but not limited to the Internet, a global network, a wide area network, a local area network, a wired network, a wireless network or any other network type including hybrids. Through the network 2820, or even directly, the controller 2800 can interface to other devices or computing platforms such as one or more servers 2822 and/or third party systems 2824. A battery or power source provides power for the controller 2800.

In the description and claims of the present application, each of the verbs, “comprise”, “include” and “have”, and conjugates thereof, are used to indicate that the object or objects of the verb are not necessarily a complete listing of members, components, elements, or parts of the subject or subjects of the verb.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art.

It will be appreciated by persons skilled in the art that the present invention is not limited by what has been particularly shown and described herein above. Rather the scope of the invention is defined by the claims that follow.

What is claimed is:

1. A method, under the control of a processing unit, for identifying the value of characteristics of an item at a point in time based on characteristic information representative of the item during a past era of time, the method comprising the actions of the processing unit:
receiving chart data representative of one or more characteristics of an item during a past era of time;
iteratively extracting varying degrees of characteristic information from the chart data for n levels;
for each degree of characteristic information, project the data to a different point in time; and
iteratively combining the projected data to create new chart data representative of one or more characteristics of the item at a different point in time; and
further comprising the action of invoking an action based at least in part on the value of the one or more characteristics at the different point in time.

2. The method of claim 1, wherein the action of iteratively extracting varying degrees of characteristic information from the chart data for n levels comprises the actions of:
(a) identifying the trend of the data represented in the current level chart data;
(b) extracting the characteristic information from the current level chart data as a function of the identified trend of the data and the current level curve data;
(c) setting a next level chart data to be the characteristic information for the current level;
(d) using the next level chart data and repeating actions (a)-(c); and
(e) after n iterations, set the margin of error as a function of the characteristic information and the chart data for the final level.

3. The method of claim 2, wherein the action of projecting the data to a different point in time for each degree of characteristic information comprises the actions of:
identifying a target point in time; and
projecting a curve represented by the identified trend of data for each level of the chart data at least to that target point in time by continuing the trend and pattern of the data.

4. The method of claim 3, wherein the action of iteratively combining the projected data to create new chart data representative of one or more characteristics of the item at a different point in time comprises the action of combining each level of the projected data at least for the data corresponding with the different point in time.

5. The method of claim 2, wherein the action of identifying the trend of the data represented in the current level chart data comprises the action of smoothing the curve represented by the chart data.

6. The method of claim 5, wherein the action of smoothing the curve comprises calculating a moving average.

7. The method of claim 2, wherein the action of extracting the characteristic information from the current level chart data as a function of the identified trend of the data and the current level curve data comprises subtracting the identified trend of the data from the curve represented by the chart data.

8. The method of claim 2, wherein the action of generating a next level chart data as a function of the characteristic information for the current level and the chart data for the current level comprises the action of subtracting the characteristic information from the current level from the chart data for the current level.

9. The method of claim 1, wherein the action of projecting the data to a different point in time for each degree of characteristic information comprises the actions of:
identifying a target point in time; and
projecting a curve represented by the characteristic information for each level at least to that target point in time by continuing the trend and pattern of the data.

10. The method of claim 1, wherein the action of iteratively combining the projected data to create new chart data representative of one or more characteristics of the item at a different point in time comprises the actions of:
combining each level of the projected data at least for the data corresponding with the different point in time.

11. The method of claim 1, further comprising the action of attributing any remaining characteristic information for the nth iteration as the margin of error.

12. The method of claim 11, wherein the iterative process is repeated until the margin of error is substantially negligible.

13. The method of claim 1, wherein the action of iteratively extracting varying degrees of characteristic information from the chart data for n levels comprises the actions of:
(a) smoothing the curve of the data represented in the current level chart data;
(b) setting a next level chart data to be the difference between the smoothed curve and the original chart data; and
(c) using the next level chart data and repeating actions (a)-(b).

14. The method of claim 13, wherein the action of smoothing the curve comprises calculating a moving average.

15. The method of claim 13, wherein the action of projecting the smoothed data to include the target point or period of time comprises:
determining if there is a repeatable pattern within the smoothed data over time period t and repeating the pattern over additional time periods t until the target point or period is included; and
if no repeatable pattern is identified, determining if there is a trend within the smoothed data over time period t and continuing the trend over additional time periods t until the target point or period is included.

16. A method, implemented within a computing environment, configured to approximate characteristics of an item for a target point or period time based on characteristic information representative of the item during a past era of time, the method comprising the actions of:
receiving data representative of one or more characteristics of an item during a past era of time;
extracting varying degrees of characteristic information from the characteristic data by:
applying a smoothing algorithm to the characteristic data over at least a portion of the past era;
subtract the smoothed data from the characteristic data to obtain remainder data;
repeat the applying action and subtracting action two or more times with the remainder data;
for each set of smoothed data, projecting the smoothed data to include the target point or period of time;
combining the projected smoothed data to create projected characteristic data representative of the one or more characteristics of the item; and
invoking an action based at least in part on the value of the one or more characteristics at the different point in time.

17. The method of claim 16, wherein the action of applying a smoothing algorithm comprises calculating a moving average.

18. The method of claim 16, wherein the action of projecting the smoothed data to include the target point or period of time comprises:
identifying a pattern within the smoothed data over time period t;
repeating the pattern over additional time periods t until the target point or period is included.

19. The method of claim 16, wherein the action of projecting the smoothed data to include the target point or period of time comprises:
identifying a trend within the smoothed data over time period t;
continuing the trend over additional time periods t until the target point or period is included.

20. The method of claim 16, wherein the action of projecting the smoothed data to include the target point or period of time comprises:
determining if there is a repeatable pattern within the smoothed data over time period t and repeating the pattern over additional time periods t until the target point or period is included; and
if no repeatable pattern is identified, determining if there is a trend within the smoothed data over time period t and continuing the trend over additional time periods t until the target point or period is included.
